(19) United States
(12) Patent Application Publication
(10) Pub. No.: US 2025/0303594 A1
(43) Pub. Date: Oct. 2, 2025

(54) SHAVING DEVICE

(71) Applicant: Insignia IP Development Company, LLC, Magnolia, TX (US)

(72) Inventors: Ruairidh Robertson, Sandwich, MA (US); Shlomo Zucker, Michmoret (IL); Samuel Hacohen, Haifa (IL)

(21) Appl. No.: 19/237,334

(22) Filed: Jun. 13, 2025

Related U.S. Application Data
(63) Continuation of application No. PCT/US23/83918, filed on Dec. 13, 2023.
(60) Provisional application No. 63/432,297, filed on Dec. 13, 2022.

(51) Int. Cl. B26B 21/22; B26B 21/40

(52) U.S. Cl. CPC B26B 21/225; B26B 21/4012

(57) ABSTRACT

A shaving device comprising a head assembly having a support member and a blade cartridge. The support member is configured to be detachably coupled to a handle. The blade cartridge has a first and a second face wherein at least one of the first or second faces comprises at least one razor blade. The blade cartridge is configured to be rotatably coupled to the support member about a pivot axis such that the blade cartridge is pivotable by a user to select one of the first or second faces.

### CROSS REFERENCE TO RELATED APPLICATION

This application is a Continuation of PCT/US23/83918, filed Dec. 13, 2023, which claims the benefit of U.S. provisional application Ser. No. 63/432,297, filed Dec. 13, 2022, the entire teachings both of which are hereby incorporated herein by reference.

### FIELD

The present disclosure relates generally to personal grooming device and, more particularly, to a personal shaving device for shaving hair.

### BACKGROUND

Shaving razors are available in a variety of forms. For example, shaving razors may include a disposable razor cartridge configured to be selectively coupled a handle. The razor cartridge may include one or more razor blades disposed on a cutting surface of the disposable razor cartridge. Once the razor blades are dull, the user may disconnect the razor cartridge from the handle and reconnect a new razor cartridge.

### FIGURES

The above-mentioned and other features of this disclosure, and the manner of attaining them, will become more apparent and better understood by reference to the following description of embodiments described herein taken in conjunction with the accompanying drawings, wherein:

FIG. 1 generally illustrates one example of a shaving device in an assembled state;

FIG. 2 generally illustrates the shaving device in an unassembled state;

FIGS. 3 and 4 generally illustrate the shaving device in an exploded state;

FIGS. 5 and 6 generally illustrate one example of a head assembly in a closed or secured position;

FIGS. 7 and 8 generally illustrate the head assembly in an open or release position;

FIG. 9 generally illustrates a partially exploded view of the shaving device;

FIG. 10 generally illustrates a first view of one example of a cartridge holder;

FIG. 11 generally illustrates a second view of one example of a cartridge holder;

FIG. 12 generally illustrates a perspective view of one example of a blade cartridge;

FIG. 13 generally illustrates an end view of the blade cartridge;

FIG. 14 generally illustrates a partially exploded view of the blade cartridge;

FIG. 15 generally illustrates a partial view of the blade cartridge, pusher, input device, and moving arm; and

FIG. 16 generally illustrates a perspective view of the blade cartridge with one example of a blade cover.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

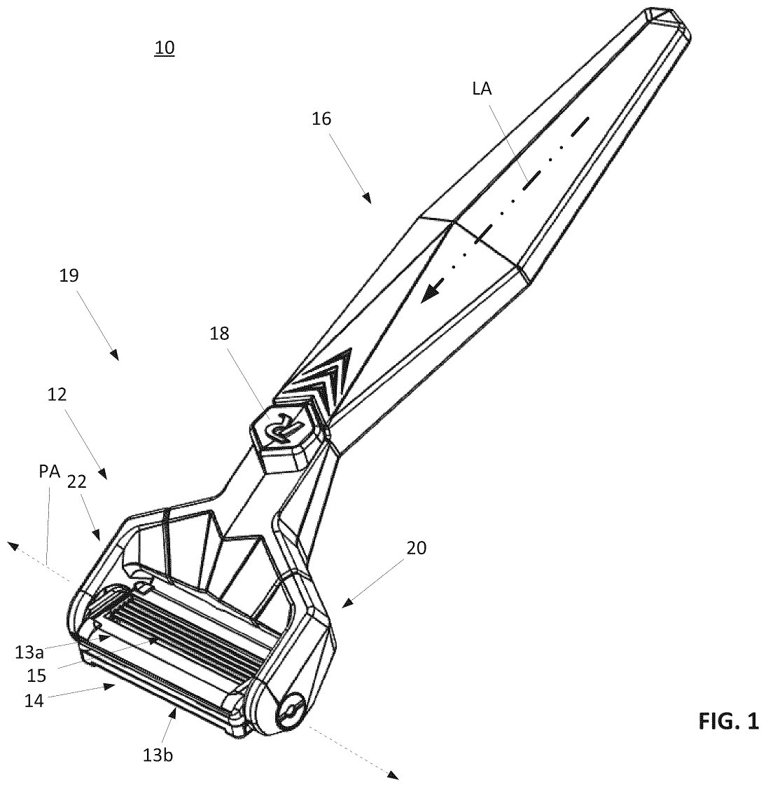

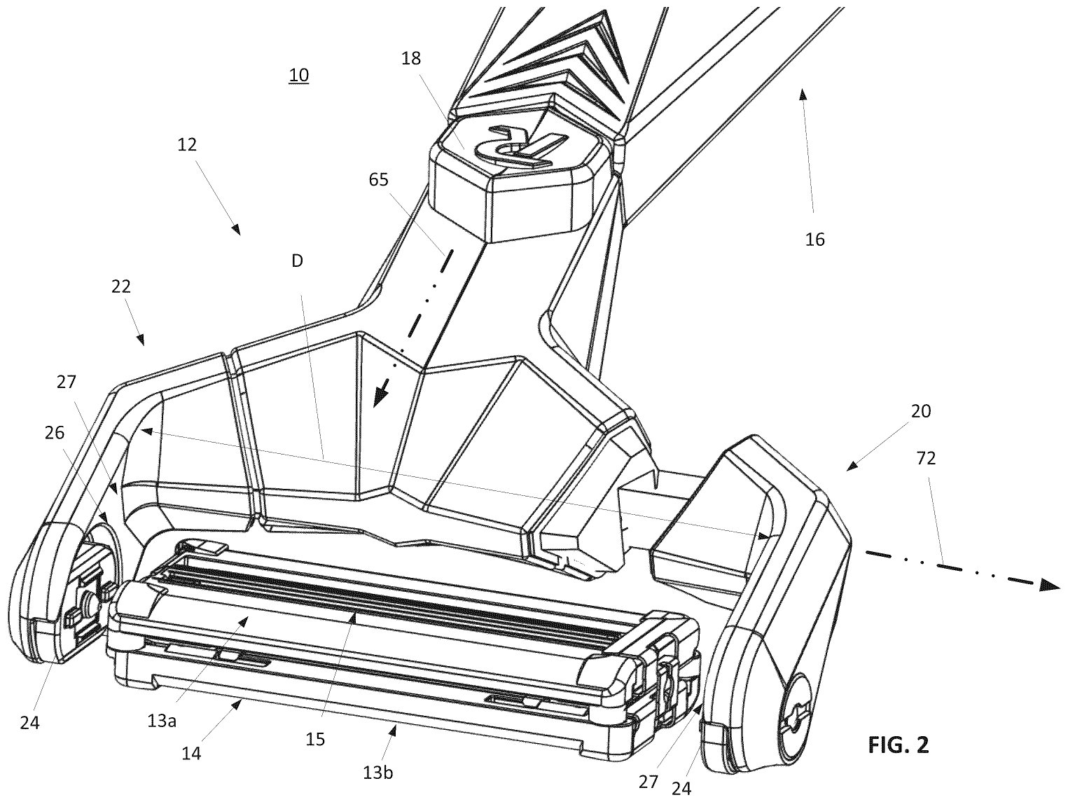

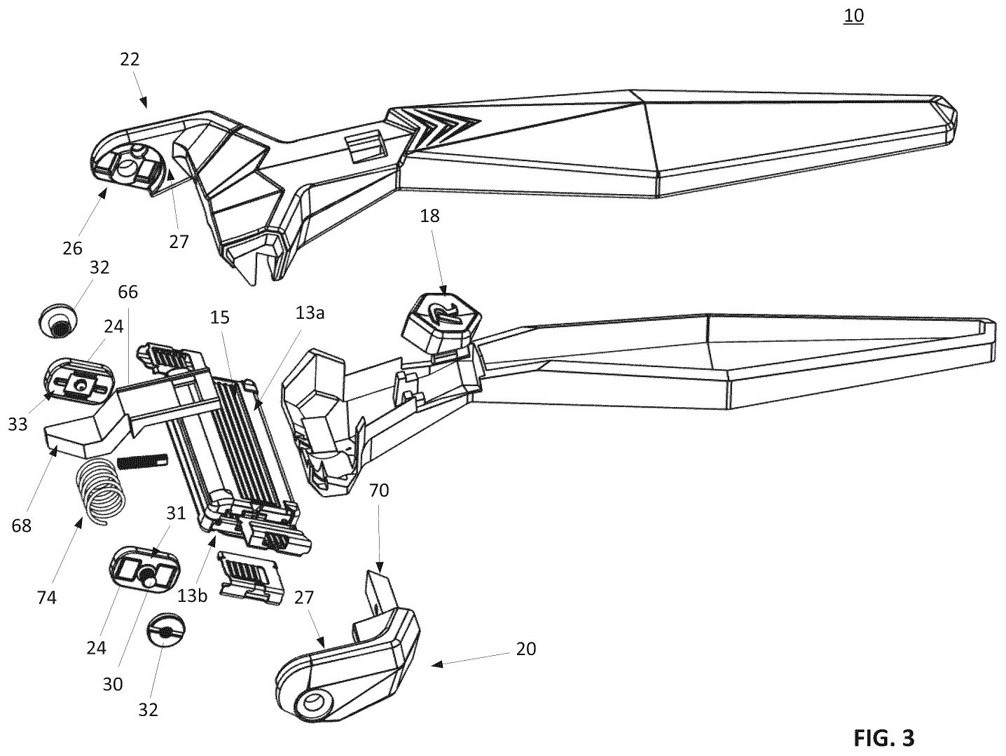

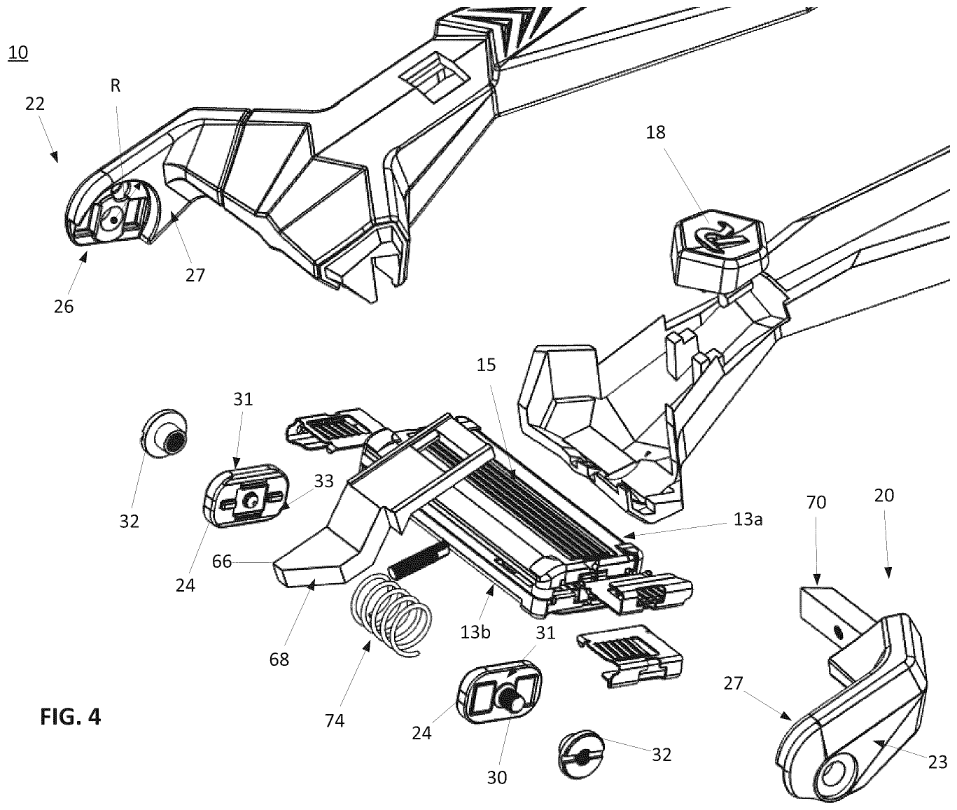

Referring to FIGS. 1-4, a personal, manual (i.e., non-powered) shaving device 10 consistent with at least one embodiment of the present disclosure is generally illustrated. In particular, FIG. 1 generally illustrates the shaving device 10 in an assembled state, FIG. 2 generally illustrates the shaving device 10 in an unassembled state, and FIGS. 3-4 generally illustrate the shaving device 10 in an exploded state. As shown, shaving device 10 comprises a head assembly 12, a blade cartridge 14, and a handle 16 configured to allow a user to hold and manipulate the shaving device 10. The blade cartridge 14 may be configured to be pivotally coupled to the disposable head assembly 12 about a pivot axis PA (see, e.g., FIG. 1) and may include one or more faces 13a, b having one or more razor blades 15 configured to shave the hair. In at least one example, the user may actuate (e.g., but not limited to, press and/or slide) an input device 18 (e.g., but not limited to, a button or the like) to release/remove the blade cartridge 14 from the head assembly 12 (as generally illustrated in FIG. 2) to allow a user to replace the blade cartridge 14 with another blade cartridge 14. The shaving device 10 may be particularly useful for shaving human hair; however, the shaving device 10 is not limited to shaving human hair unless specifically claimed as such.

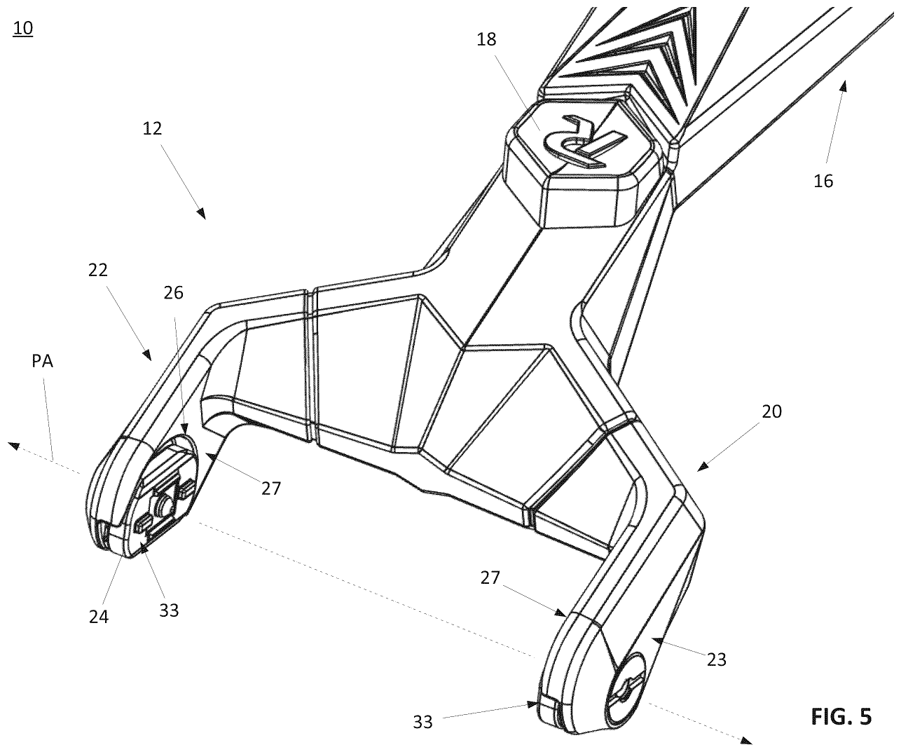

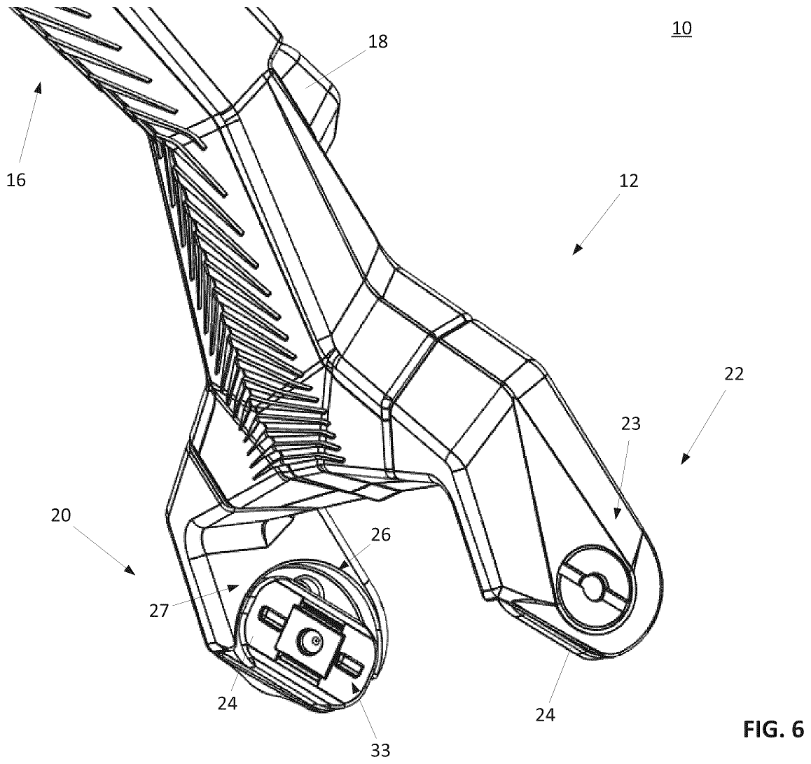

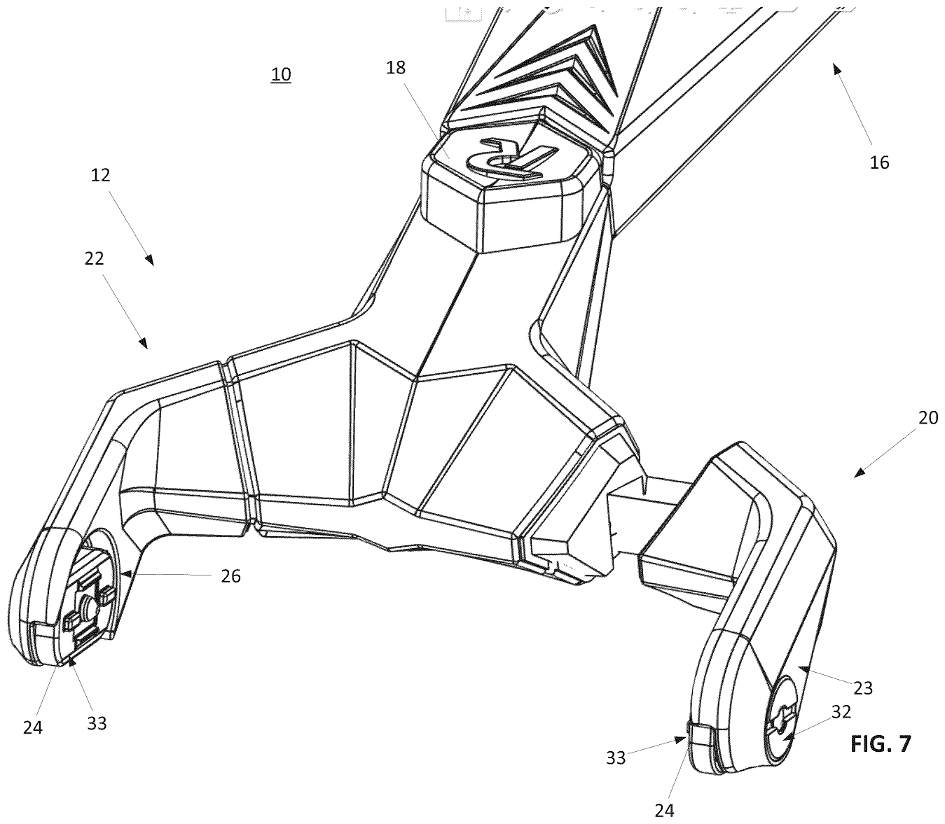

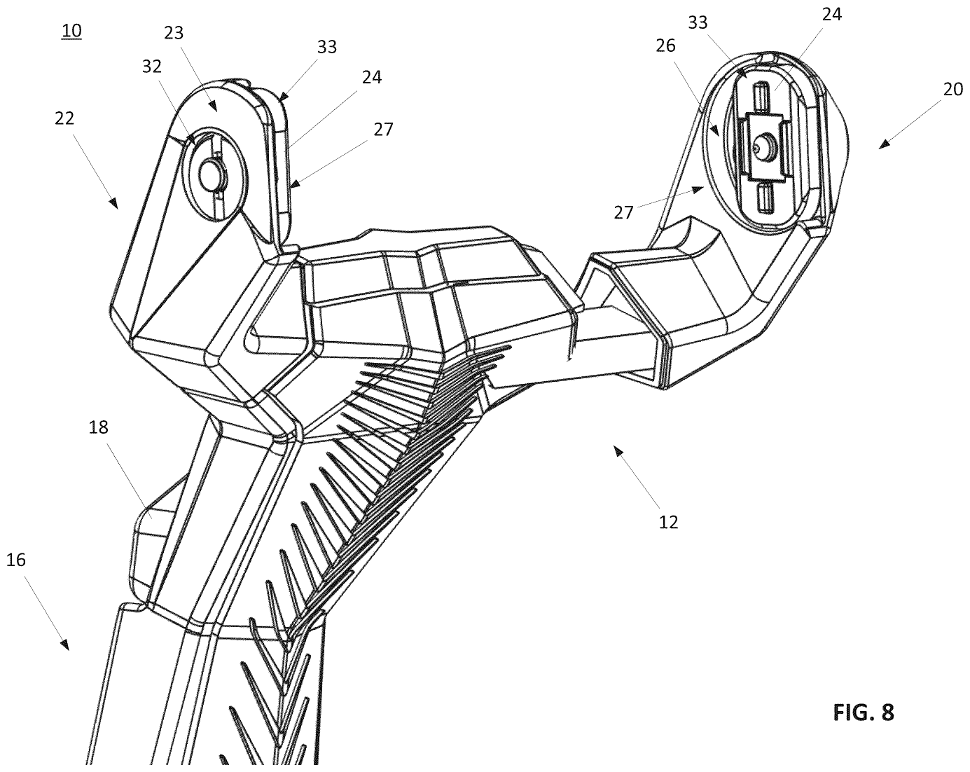

Turning to FIGS. 5-8, one example of the of the shaving device 10 is shown with the blade cartridge 14 removed/disconnected. In particular, FIGS. 5-6 generally illustrate the head assembly 12 in a closed or secured position (i.e., the head assembly 12 is configured to be coupled to and retain the blade cartridge 14 in this state) and FIGS. 7-8 generally illustrate the head assembly 12 in an open or release position (i.e., the head assembly 12 is configured to be uncoupled and removed from the blade cartridge 14 in this state).

The head assembly 12 includes a first and a second arm 20, 22. Each arm 20, 22 may include a cartridge holder 24 configured to be releasably secured to and engage the blade cartridge 14. The cartridge holders 24 may be configured to pivot about the pivot axis PA (see, e.g., FIGS. 1 and 5). The cartridge holders 24 may also be biased towards one or more initial starting positions. As used herein, an initial starting position refers to a position of the cartridge holders 24 which, when coupled to the blade cartridge 14, correspond to a use position of the face 13 of the blade cartridge 14. When used in combination with a blade cartridge 14 having a plurality of faces 13a, b, the cartridge holders 24 may also have a corresponding plurality of initial starting positions, each initial starting position corresponding to a unique one of the plurality of faces 13a, b of the blade cartridge 14. The use position of the face 13 of the blade cartridge 14 corresponds to the position of the blade cartridge 14 relative to the head assembly 12 and/or handle 16 in which the face 13 of the blade cartridge 14 that is intended to be used by user (e.g., a face having one or more razor blades 18 that are to be used for shaving) is aligned relative to the head assembly 12 and/or handle 16 to allow the user to shave. The blade cartridge 14 may therefore also be said to include one or more initial starting positions (i.e., a position of the blade cartridge 14 in which a selected face 13 of the blade cartridge 14 is aligned relative to the head assembly 12 and/or handle 16 such the face 13 of the blade cartridge 14 can be used for shaving when coupled to the head assembly 12 and/or handle 16).

In some examples, the cartridge holders 24 (and therefore the blade cartridge 14 when secured thereto) may pivot clockwise and/or counterclockwise about the pivot axis PA relative to the initial starting position. For example, the cartridge holders 24 may pivot 360 degrees clockwise and/or counterclockwise about the pivot axis PA. Alternatively (or in addition), the cartridge holders 24 (and therefore the blade cartridge 14 when secured thereto) may be configured to pivot clockwise and/or counterclockwise about the pivot axis PA only a predetermined number of degrees relative to the initial starting position (e.g., less than 360 degrees). For example, the cartridge holders 24 may pivot up to 20 degrees pivot clockwise and/or counterclockwise about the pivot axis PA relative to the initial starting position, up to 30 degrees pivot clockwise and/or counterclockwise about the pivot axis PA relative to the initial starting position, up to 45 degrees pivot clockwise and/or counterclockwise about the pivot axis PA relative to the initial starting position, up to 20 degrees pivot clockwise and/or counterclockwise about the pivot axis PA relative to the initial starting position, up to 60 degrees pivot clockwise and/or counterclockwise about the pivot axis PA relative to the initial starting position, and/or up to 90 degrees pivot clockwise and/or counterclockwise about the pivot axis PA relative to the initial starting position, including all ranges and values therein.

The cartridge holders 24 may rotate different amounts in the clockwise direction compared to the counterclockwise direction. As used herein, the clockwise direction is defined as the direction when viewed from the right-hand side 19 of the shaving device (as shown in FIG. 1). For example, rotation of the cartridge holders 24 may be restricted and/or prevented in the counterclockwise direction (compared to the clockwise direction) to generally prevent a user from accidentally rotating the cartridge holders 24 to the next initial starting position (e.g., when used with a blade cartridge 14 having two faces 13a, b). As such, the user may have to rotate the cartridge holders 24 in the clockwise direction in order to move from a first face (e.g., face 13a) to another face (e.g., face 13b). Rotation in the clockwise direction may minimize accidental selection of another face more of the blade cartridge 14 may be blocked by the arms 22, 22, thereby requiring a more deliberate action by the user to select the next face. Of course, the rotation of the cartridge holders 24 may alternatively be restricted and/or prevented in the clockwise direction (compared to the counterclockwise direction) in the same manner.

The cartridge holders 24 may optionally rotate within a holder cavity 26 formed in arms 20, 22 (see, e.g., FIGS. 5-9). The holder cavities 26 may be disposed at least partially on/in an inner surface 27 of the arm 20, 22 (i.e., the side of the arm 20, 22 that generally faces the opposite arm 20, 22). The holder cavity 26 may be configured to allow the cartridge holder 24 to be at least partially received into the arm 20, 22. For example, the holder cavity 26 may be configured such that an inward face 33 of the cartridge holder 24 is substantially flush with the inner surface of the arm 20, 22. For example, the holder cavity 26 may be configured such that an inward face 33 of the cartridge holder 24 is within +/−1-3 mm of the inner surface of the arm 20, 22.

As used herein, the inward face 33 of the cartridge holder 24 is defined as the face of the cartridge holder 24 that faces the opposite arm 20, 22 to which it is coupled. The inward faces 33 of the cartridge holders 24 therefore face generally away from each other. In contrast, an outward face 31 of the cartridge holder 24 is defined as the face of the cartridge holder 24 that faces the corresponding arm 20, 22 to which it is coupled. The outward faces 31 of the cartridge holders 24 therefore face away from each other.

The holder cavity 26 may have an arcuate outer profile generally centered around the pivot axis PA that allows the cartridge holder 24 be at least partially received into the arm 20, 22. The radius R of the arcuate outer profile of the holder cavity 26 may be at least as large as the maximum distance between the pivot axis and the outer periphery of the cartridge holder 24. In least one example, the radius R of the holder cavity 26 may be 1-10 mm greater than the maximum distance between the pivot axis and the outer periphery of the cartridge holder 24 in order to allow sufficient clearance for debris such as hair and/or shaving cream.

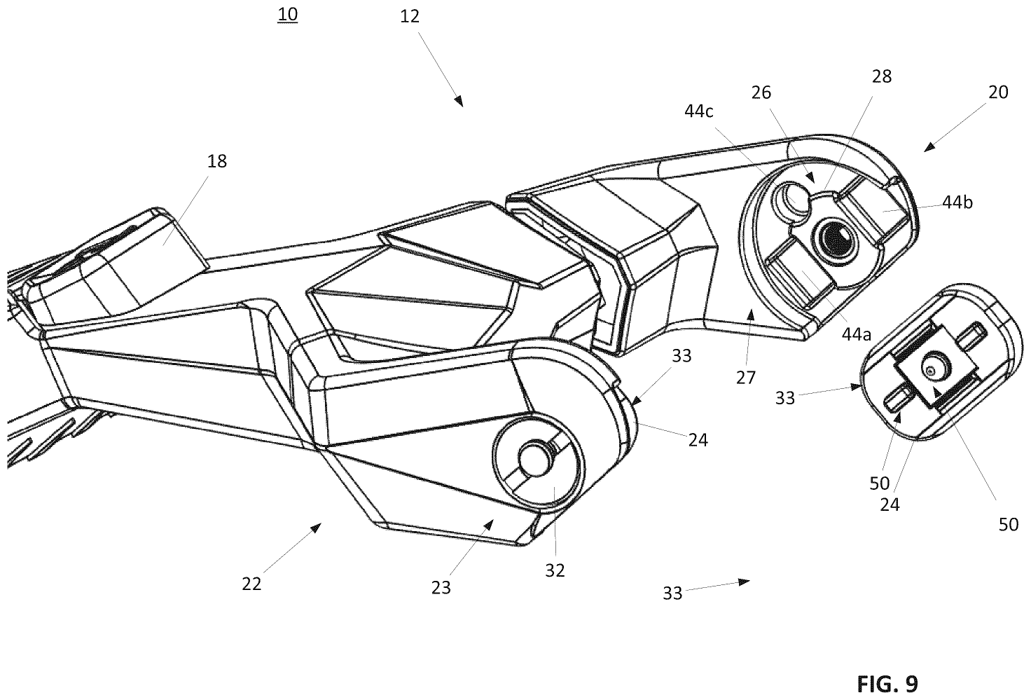

The cartridge holders 24 may be pivotally secured to the arms 20, 22. One or more bushing 28 (best seen in FIG. 9) may be provided between the cartridge holder 24 and the arms 22, 22 to facilitate rotation of the cartridge holders 24 relative to the arms 20, 22. The cartridge holders 24 may rotate about pivot pins. In the illustrated example, the pivot pin 30 (see, e.g., FIGS. 3, 4, and 10) may include a pivot pin extending from an outward face 31 of the cartridge holder 24.

By way of a non-limiting example, the pivot pin 30 may include a threaded pivot pin configured to engage with a corresponding threaded outer retainer 32 (e.g., a threaded nut). The outer retainer 32 may be at least partially disposed on or about an exterior surface 23 of the arm 20, 22 (e.g., opposite the holder cavity 26). The threaded outer retainer 32 may threadably engage the threaded pivot pin 30 to secure the arm 20, 22 (e.g., within the bushing 28). The threaded pivot pin 30 and threaded outer retainer 32 may facilitate assembly of the shaving device 10. Of course, the cartridge holders 24 may be pivotally secured to the arm 20, 22 in any manner known to those skilled in the art. For example, the pivot pin 30 may be secured to an outer retainer 32 and/or bushing 28 using an adhesive and/or a rivet coupling. Alternatively (or in addition), the outer retainer 32 may include a washer and a c-clip or snap ring. The c-clip or snap ring may engage a groove formed in the washer and/or on the pivot pin 30. Of course, the pivot pin 30 may extend from the outer retainer 32 and may engage the cartridge holder 24 in any manner described herein or otherwise known to those skilled in the art.

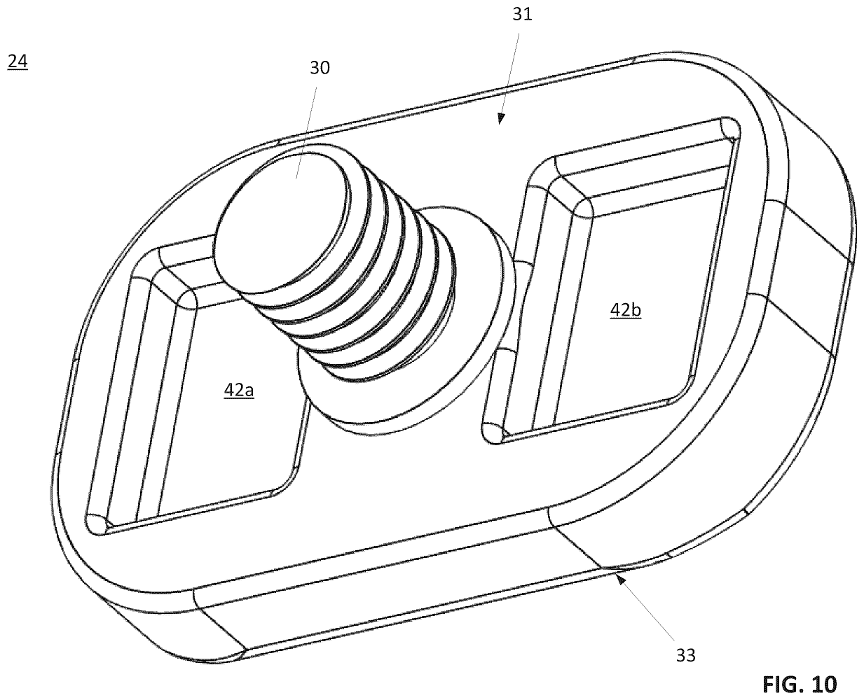

The cartridge holder 24 may be biased towards an initial starting position by way of a biasing mechanism. The biasing mechanism may include one or more springs or the like configured to urge the cartridge holder 24 to an initial starting position. Alternatively (or in addition), the biasing mechanism may include one or more magnets configured to generate a magnetic force that urges the cartridge holder 24 towards an initial starting position using one or more magnets. For example, the biasing mechanism may include one or more magnets 42 (also referred to as blade cartridge magnets or holder magnets, e.g., magnets 42a, b, best seen in FIG. 10) coupled to the cartridge holder 24 and/or one or more blade cartridge support member magnet 44 (e.g., blade cartridge support member magnet 44a, b, best seen in FIG. 9) coupled to the arms 20, 22. The holder magnets 42 and the blade cartridge support member magnet 44 may be configured to generate an attractive magnetic force and/or a repulsive magnetic force. In any case (e.g., attractive and/or repulsive magnetic force), the magnetic force may be configured to urge the cartridge holder 24 (and therefore the blade cartridge 14 when secured thereto) towards an initial starting position relative to the arms 20, 22.

In at least one example, one or more of the arms 20, 22 may include at least one blade cartridge support member magnet 44 while one or more of the cartridge holders 24 may include one or more holder magnets 42. In the illustrated example, a cartridge holder 24 may include a first and at least a second holder magnet 42a, b (wherein the first holder magnet 42a corresponds to a first initial starting position and the second holder magnets 42b corresponds to a second initial starting position). One or more of the arms 20, 22 may include a first and at least a second cartridge support member magnet 44a, b. The second cartridge support member magnet 44b may be configured to generate the same or different magnetic force (i.e., attractive or repulsive magnetic force) as the first cartridge support member magnet 44a. For example, the first cartridge support member magnet 44a may configured to generate an attractive magnetic force with one or more of the holder magnets 42a, b while the second cartridge support member magnet 44b may configured to generate a repulsive magnetic force with one or more of the holder 42a, b. Such a configuration may be referred to as a pull-push configuration. Of course, the first cartridge support member magnet 44a may configured to generate a repulsive magnetic force with one or more of the holder magnets 42a, b while the second cartridge support member magnet 44b may configured to generate an attractive magnetic force with one or more of the holder magnets 42 a, b. Such a configuration may be referred to as a push-pull configuration.

In either case, the first cartridge support member magnet 44a may be disposed below the pivot axis PA (i.e., proximate handle 16) and the second cartridge support member magnet 44b may be disposed above the pivot axis PA (i.e., generally away from the handle 16). For example, the first and second cartridge support member magnets 44a, b may be disposed on generally radially opposite sides of the pivot axis PA.

One or more of the holder magnets 42 may be flush with the outward face 31 of the blade cartridge 14. Alternatively (or in addition), one or more of the holder magnets 42 may be recessed from the outward face 31 of the blade cartridge 14 and/or extend outwardly away from the outward face 31 of the blade cartridge 14.

One or more of the blade cartridge support member magnets 44 may be flush with the inner surface 27 (e.g., the base of the holder cavity 26) of the arms 20, 22. Alternatively (or in addition), one or more of the blade cartridge support member magnets 44 may be recessed from the inner surface 27 (e.g., the base of the holder cavity 26) of the arms 20, 22 and/or extend outwardly away from the inner surface 27 (e.g., the base of the holder cavity 26) of the arms 20, 22.

Alternatively (or in addition), one or more cartridge support member magnets 44 may be referred to as a supplemental or helper cartridge support member magnet 44c. The helper cartridge support member magnet 44c may be radially offset between 10 to 100 degrees about the pivot axis PA from the position of the first or second cartridge support member magnet 44a, b. In at least one example, the helper cartridge support member magnet 44c may be radially offset between 10 to 90 degrees, for example, 10 to 45 degrees, and/or 10 to 30 degrees about the pivot axis PA from the position of the first or second cartridge support member magnet 44a, b, including all ranges and values therein. The helper cartridge support member magnet 44c may be configured to provide a force urging the cartridge holder 24 towards either a current initial starting position (i.e., the initial starting position from which the cartridge holder 24 moved away from) and/or towards a new initial starting position (i.e., away from the current initial staring position). The helper cartridge support member magnet 44c may be configured to generally prevent the cartridge holders 24 may inadvertently becoming aligned in an intermediate position between the first and second initial starting positions.

In any of the examples described herein, one or more of the holder magnets 42 and/or blade cartridge support member magnet 44 may be configured to generate a magnetic force with a ferrous element. The ferrous elements may be disposed on the arms 20, 22, the cartridge holder 24, and/or the blade cartridge 14. The ferrous elements may be in lieu of one or more of the holder magnets 42 and/or blade cartridge support member magnet 44. Alternatively, the ferrous elements may be in addition to both the holder magnets 42 and blade cartridge support member magnets 44.

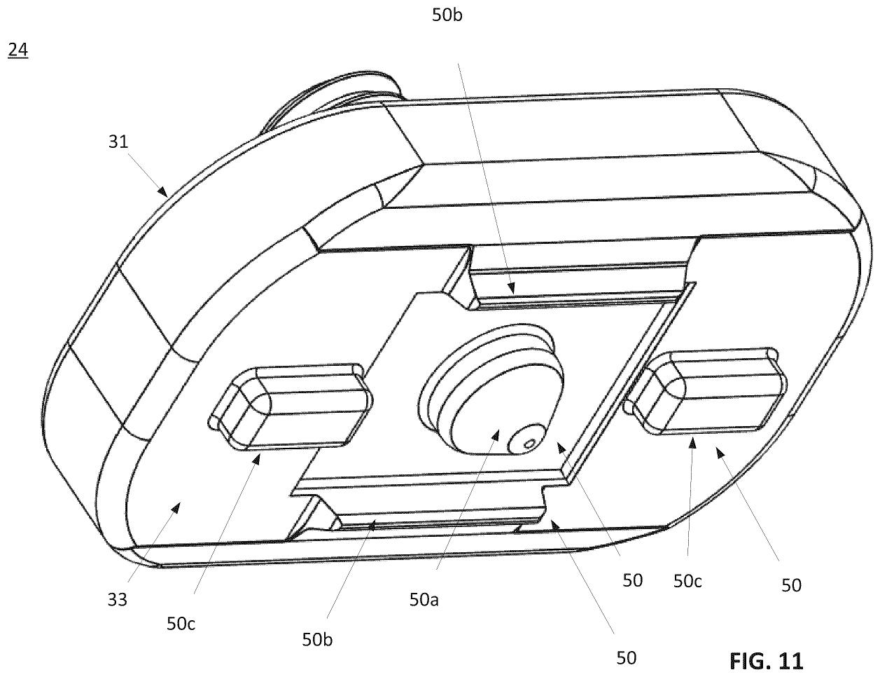

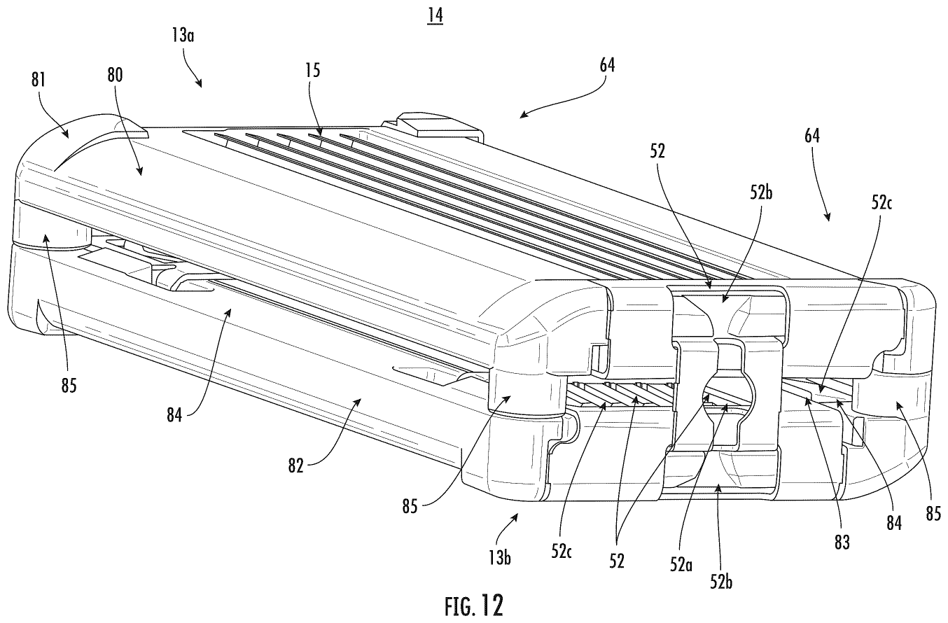

As noted herein, the cartridge holder 24 may be configured to be removably secured to the blade cartridge 14. The cartridge holder 24 may be configured to be secured to the blade cartridge 14 in any manner that generally prevents movement (e.g., rotation) of the blade cartridge 14 relative to the cartridge holder 24. In at least one example, the inward face 33 of the cartridge holder 24 may include one or more retaining tabs/protrusions and/or one or more retaining cavities/slots 50 (see, e.g., FIG. 11) configured to engage with one or more retaining tabs/protrusions and/or one or more retaining cavities/slots 52 (see, e.g., FIG. 12) of the blade cartridge 14.

For example, the inward face 33 of the cartridge holder 24 may include a centrally located retaining protrusion 50a (see, e.g., FIG. 11). The centrally located retaining protrusion 50a may include a tapered portion (e.g., but not limited to, a tapered distal end) configured to facilitate alignment of the cartridge holder 24 relative to the blade cartridge 14. The centrally located retaining protrusion 50a may be at least partially received in a centrally located retaining cavity/slot 52a (see, e.g., FIG. 12), for example, formed in the end face or lateral end region 64 of the blade cartridge 14. The centrally located retaining protrusion 50a and centrally located retaining cavity/slot 52a may have a generally circular cross-section as shown; however, the centrally located retaining protrusion 50a and centrally located retaining cavity/slot 52a may alternatively have a non-circular cross-sectional shape configured to generally prevent relative rotation. The centrally located retaining protrusion 50a and centrally located retaining cavity/slot 52a may be aligned along (e.g., concentric with) the pivot axis PA.

The inward face 33 of the cartridge holder 24 may alternatively (or additionally) include one or more upper and/or lower retaining tabs/protrusions 50b (see, e.g., FIG. 11) and/or one or more fore and/or aft retaining tabs/protrusions 50c. The upper, lower, fore, and/or aft retaining tabs/protrusions 50b, c may be keyed (e.g., sized and shaped) with corresponding upper and/or lower retaining cavities/slots 52b (see, e.g., FIG. 12) and/or fore and/or aft retaining cavities/slots 52c formed in the end face or lateral end region 64 of the blade cartridge 14. The keyed arrangement may allow the blade cartridge 14 to be secured to the cartridge holder 24 in either only a single position or in only two positions. Of course, one or more of the central, upper, lower, fore, and/or aft retaining tabs/protrusions 50a, b, c may be replaced with a cavity or slot configured to engage/receive a corresponding retaining tabs/protrusions 52a, b, c associated with the blade cartridge 14.

Alternatively (or in addition), the cartridge holder 24 may be removably secured to the blade cartridge 14 using one or more retaining magnets. For example, the cartridge holder 24 may include one or more retaining magnets and/or ferrous elements configured to form a magnetic connection with one or more retaining magnets and/or ferrous elements secured to the blade cartridge 14 (e.g., one or more retaining magnets and/or ferrous elements formed in the end face or lateral end region 64 of the blade cartridge 14). The magnetic connection may include an attractive magnetic connection and/or a repulsive magnetic connection (e.g., a repulsive magnetic connection as described in U.S. Pub. No. 2022/0055239, filed Mar. 26, 2020, which is fully incorporated herein by reference).

Referring back to FIGS. 1 and 2, the shaving device 10 is generally illustrated in an assembled state (FIG. 1) and in an unassembled state (FIG. 2). For example, upon activation (e.g., pressing, sliding, rotating, and/or the like), one or more of the cartridge holders 24 may be configured to move away from each other to increase the separate distance D between the cartridge holders 24. The separation distance D may correspond to the distance between the inward faces 33 of the cartridge holders 24. As the separation distance D increases, the retaining tabs/protrusions and/or one or more retaining cavities/slots 50 associated with the cartridge holder 24 disengage with the retaining tabs/protrusions and/or one or more retaining cavities/slots 52 associated with the blade cartridge 14, thereby allowing the blade cartridge 14 to be removed from the head assembly 12.

In the illustrated example, the cartridge holders 24 may move apart from each other by virtue of one or more of the arms 20, 22 moving away from each other. For example, the arms 20, 22 move linearly away from each other. Alternatively, the arms 20, 22 may move nonlinearly away from each other (e.g., but not limited to, along an arc or the like).

In the illustrated example, the second arm 22 is stationary with respect to the head assembly 12 and/or handle 16 and the first arm 20 is configured to move with respect to the second arm 22, the head assembly 12, and/or the handle 16. It should be appreciated, however, that both arms 20, 22 may move with respect to each other, the head assembly 12, and/or the handle 16.

In an alternative example, the cartridge holders 24 may move apart from each while one or both of the arms 20, 22 are stationary with respect to the head assembly 12 and/or the handle 16.

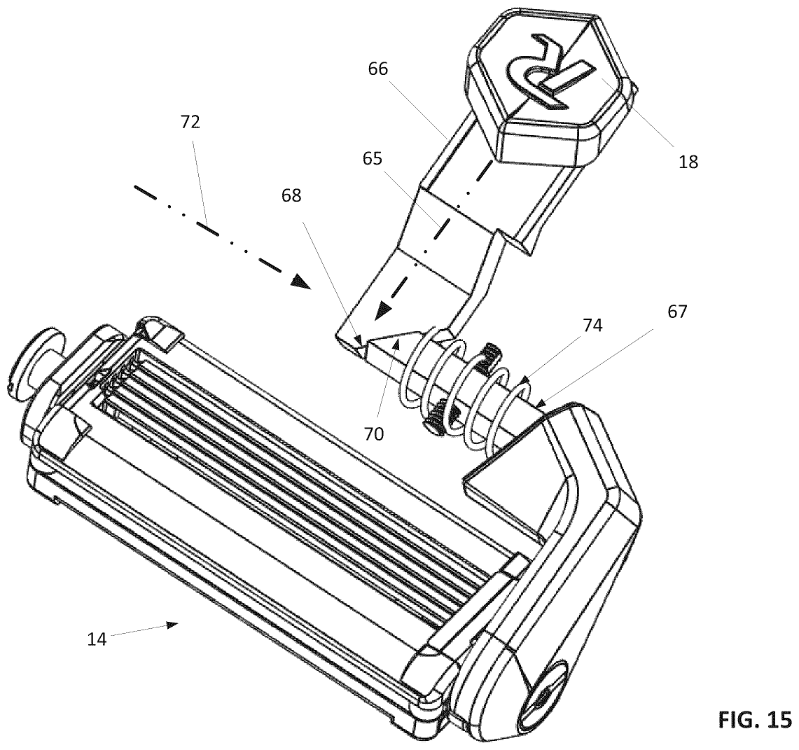

With reference to FIGS. 3-4 and 15, to move the cartridge holders 24 from the secured position (e.g., FIG. 1) to the release position (e.g., FIG. 2), the user may actuate (e.g., but not limited to, press and/or slide) an input device 18. The input device 18 may include, but is not limited to, a button or the like. The user may press or slide the button 18 (e.g., slide button 18 in direction of arrow 65) which urge a pusher 66 towards the head assembly 12. Arrow 65 may be generally parallel to the longitudinal axis LA of the shaving device 10. The pusher 66 may be restrained within the head assembly 12 and/or the handle 16 such that it can substantially only move in the direction of arrow 65. The pusher 66 may include a tapered or cam surface 68 which may engage (e.g., contact) a corresponding tapered or cam surface 70 coupled to the moving arm 20. The tapered or cam surface 70 may be formed a distal end of an extension or finger 67 extending from a portion of the moving arm 20, e.g., generally towards the longitudinal axis LA of the shaving device 10 and/or generally towards the other arm 22. The tapered or cam surfaces 68, 70 may be configured to translate movement of the pusher 66 in the direction of arrow 65 into movement of the moving arm 20 generally in the direction of arrow 72. Arrow 72 may be in a direction which is generally opposite and/or away from the other arm 22. For example, arrow 72 may be transverse to the longitudinal axis LA of the shaving device 10 such as, but not limited to, generally perpendicular to the longitudinal axis LA. The movement of the moving arm 20 generally in the direction of arrow 72 may be against a return or biasing device 74 (e.g., a spring and/or a magnetic force generated by one or more magnets in either attraction or repulsion). The biasing device 74 may urge the moving arm 20 generally to the secured position (e.g., as shown in FIG. 1). The biasing device 74 may therefore be configured to provide a return and/or clamping force that urges the cartridge holders 24 into a secure connection with the blade cartridge 14. Once the user removes the force applied to the input device 18, the clamping force generated by the biasing device 74 may urge the moving arm 20 to the secured position, thereby causing the cartridge holders 24 to engage and fixedly secure the blade cartridge 14 to the head assembly 12.

While the above description includes one moving arm 20 and one stationary arm 22, it should be appreciated that both arms 20, 22 may be moving arms. In such an arrangement, the pusher 66 may include a tapered or camming surface 68 configured to move both arms 20, 22, for example, in generally opposite directions. For example, the pusher 66 may include two tapered or camming surface 68 and arm 22 may include a tapered or camming surface 70 and biasing device 74 as well.

While one or more of the arms 20, 22 have been described as moving with respect to the head assembly 12 and/or handle 16, it should be appreciated the substantially the same mechanism could also be applied to move one or more of the cartridge holders 24 while both arms 20, 22 remain stationary.

Of course, the present disclosure is not limited to the configuration described herein for moving the cartridge holders 24 between the secured position and release position. The present disclosure may include any mechanism for allowing the cartridge holders 24 to move between the secured position and release position.

In addition, while the blade cartridge 14 is shown having razor blades 15 on two faces 13a, b, it should be appreciated that the blade cartridge 14 may have one or more razor blades on only one side/face 13. Additionally, the blade cartridge 14 may have one or more razor blades on more than two sides/faces 13.

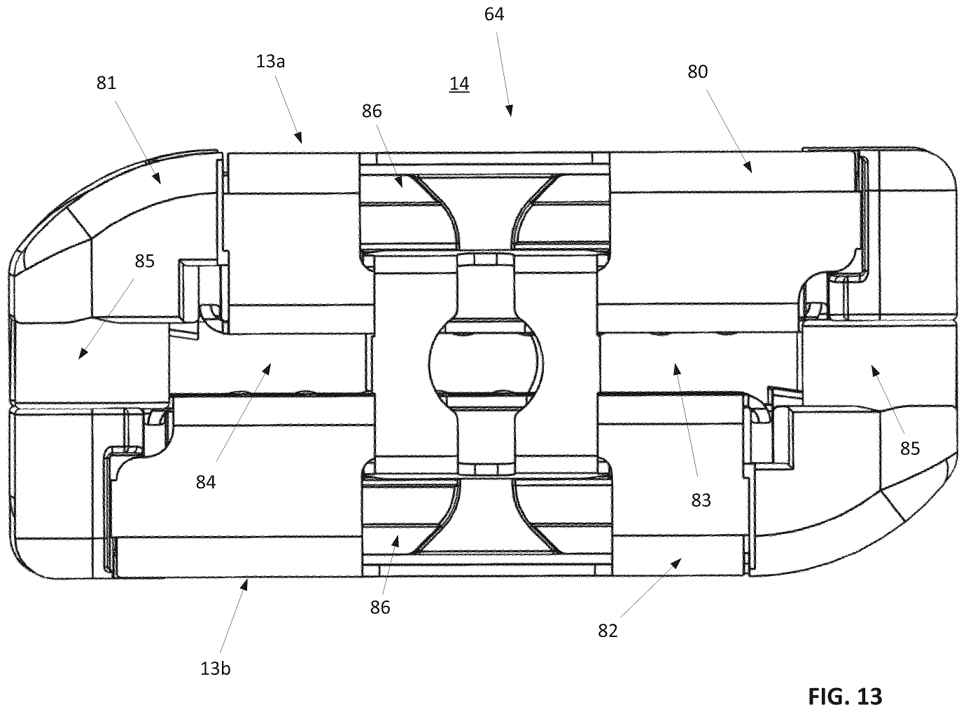

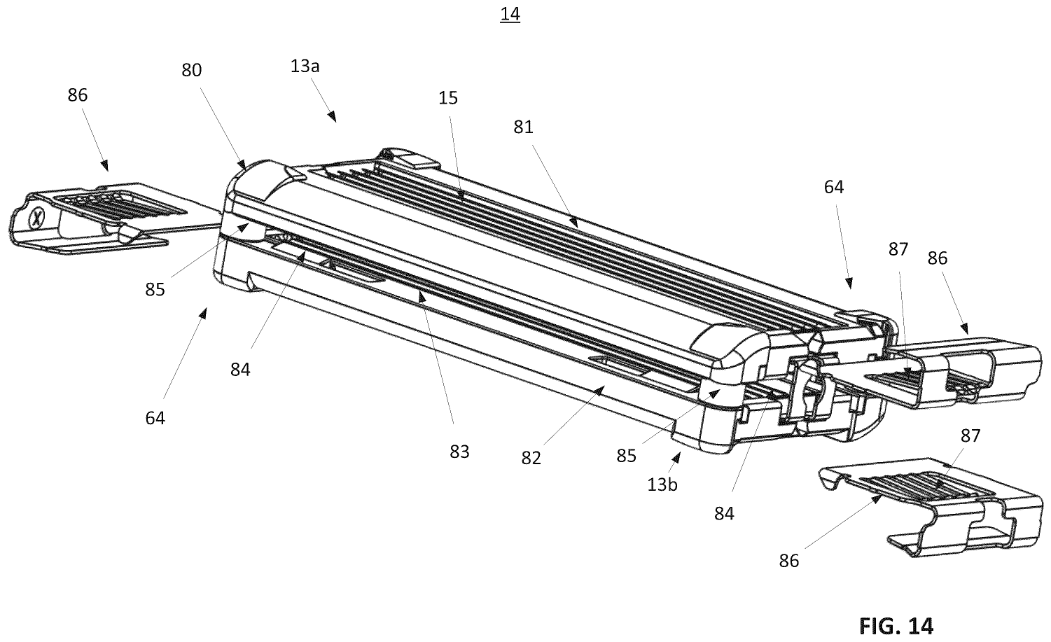

Turning to FIGS. 12-14, the blade cartridge 14 may include a frame 80. The frame 80 may include a first and a second body 81, 82 configured to be secured together. The first and second body 81, 82 may define a central open region 83 and one or more outlets 84 in fluid communication with the environment configured to allow debris (e.g., shaving cream, cut hair, and/or the like) to flow between the razor blades 15 on each face 13 and out of the blade cartridge 14. The blade cartridge 14 may include one or more standoffs 85. The standoffs 85 may be configured to space apart the first and second body 81, 82 to at least partially define the central open region 83. The standoffs 85 may be formed from portions of the second body 81, 82. One or more razor blade retainers 86 may be provided to secure the razor blades 15 to the face 13 of the first and/or second body 81, 82. The razor blade retainers 86 may optionally include one or more blade biasing elements 87 (e.g., but not limited to, springs such as finger springs or the like) to bias the razor blades 15 generally outwardly.

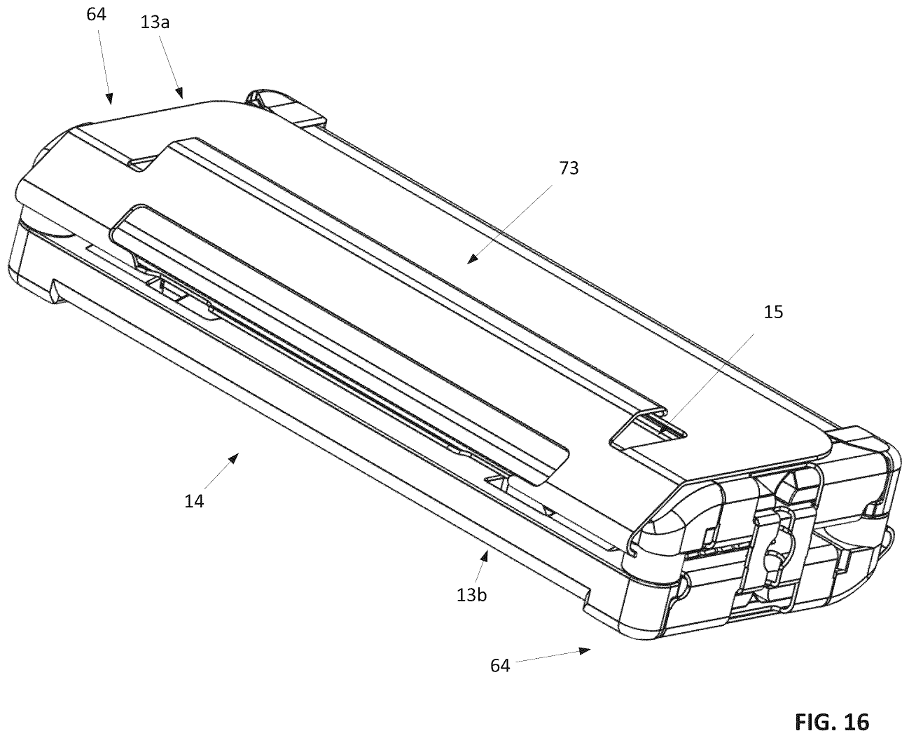

Turning finally to FIG. 16, the blade cartridge 14 may optionally include a blade cover 73. The blade cover 73 may be configured to be releasably secured to the blade cartridge 14 and extend over at least a portion of the razor blades 15 to generally prevent accidental contact with the razor blades 15. The blade cover 73 may be releasably secured to the blade cartridge 14 in any manner known to those skilled in the art. For example, the blade cover 73 may be include one or more clips configured to releasably secure the blade cover 73 to the blade cartridge 14.

The term substantially is intended to mean within 10% unless otherwise specifically described herein.

While preferred embodiments of the present disclosure have been described, it should be understood that various changes, adaptations, and modifications can be made therein without departing from the spirit of the invention(s) and the scope of the appended claims. The scope of the present disclosure should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

What is claimed is:

1. A shaving device comprising:
a handle; and
a head assembly disposed about a first end of the handle, the head assembly comprising:
a support member comprising a first and a second support arm;
a blade cartridge having at least one razor blade, the blade cartridge configured to pivot about a pivot axis from an initial starting position;
one or more cartridge holders configured to be releasably secured to and engage the blade cartridge, the cartridge holder configured to pivot about the pivot axis;
one or more holder magnets configured to rotate with the cartridge holder as the cartridge holder is rotated about the pivot axis; and
one or more blade cartridge support member magnets secured to the first arm;
wherein the one or more holder magnets and the one or more blade cartridge support member magnets are configured to create a magnetic biasing force to urge the blade cartridge towards the initial starting position.

2. The shaving device of claim 1, wherein the at least one razor blade includes a first and a second razor blade and wherein blade cartridge includes a first and a second face including the first and the second razor blade, respectively.

3. The shaving device of claim 2, wherein the magnetic biasing force includes an attractive magnetic force.

4. The shaving device of claim 2, wherein the magnetic biasing force includes a repulsive magnetic force.

5. The shaving device of claim 2, wherein the magnetic biasing force includes both an attractive magnetic force and a repulsive magnetic force.

6. The shaving device of claim 2, wherein the one or more holder magnets are configured to be releasably coupled to the blade cartridge.

7. The shaving device of claim 2, wherein the one or more holder magnets includes a first and a second holder magnet located on opposite sides of the pivot axis.

8. The shaving device of claim 2, wherein the one or more blade cartridge support member magnets are located in a distal section of at least one of the support arms.

9. The shaving device of claim 2, wherein the one or more cartridge holders includes a first cartridge holder and a second cartridge holder pivotally coupled to the first support arm and second support arm, respectively, and wherein the first cartridge holder and the second cartridge holder are configured to remain pivotally coupled to the first support arm and second support arm after the blade cartridge is unsecured from the first cartridge holder and the second cartridge holder.

10. The shaving device of claim 9, wherein the one or more holder magnets include a first holder magnet and a second holder magnet configured to be secured to the first cartridge holder and the second cartridge holder after the blade cartridge is unsecured from the first cartridge holder and the second cartridge holder.

11. The shaving device of claim 1, wherein the blade cartridge does not include a magnet.

12. The shaving device of claim 1, wherein the at least one razor blade includes a first razor blade and a second razor blade, and wherein the blade cartridge includes a first body defining a first face and including the first razor blade, a second body defining a second face and including the second razor blade, one or more standoffs configured to space apart the first body from the second body to at least partially define a central open region between the first body and the second body, and one or more outlets configured to allow debris to flow between the first razor blade and the first face to the central open region through the central open region and out of the one or more outlets and to flow between the second razor blade and the second face to the central open region and out of the one or more outlets.

13. The shaving device of claim 2, wherein the one or more cartridge holders includes a first cartridge holder and a second cartridge holder pivotally coupled to the first and second support arm, respectively.

14. The shaving device of claim 13, wherein the first cartridge holder and the second cartridge holder are biased towards each other.

15. The shaving device of claim 2, wherein the one or more cartridge holders and the blade cartridge include at least one retaining tab/protrusion and retaining cavity/slot configured to prevent movement of the blade cartridge relative to the one or more cartridge holders.

16. The shaving device of claim 1, wherein the second arm is stationary with respect to the head assembly and the first arm is configured to move with respect to the head assembly.

17. The shaving device of claim 16, wherein the first arm is configured to move linearly with respect to the head assembly between a secured position and a release position, wherein the blade cartridge is secured to the one or more cartridge holders in the secured position and wherein the blade cartridge is unsecured to the one or more cartridge holders in the release position.

18. The shaving device of claim 17, wherein the first arm is configured to move linearly with respect to the head assembly along an axis that is parallel to the pivot axis.

19. The shaving device of claim 16, wherein further comprising a biasing device configured to generate a clamping force that urges the first arm to the secured position, thereby causing the one or more cartridge holders to engage and fixedly secure the blade cartridge to the head assembly.

20. The shaving device of claim 1, wherein the blade cartridge is stationary with respect to the one or more cartridge holders when the blade cartridge is secured to the one or more cartridge holders.
